(19) United States
(12) Patent Application Publication
(10) Pub. No.: US 2021/0020074 A1
(43) Pub. Date: Jan. 21, 2021

(54) SECURITY STICKER

(71) Applicant: Yun Sik LEE, Cheongju-si (KR)

(72) Inventor: Yun Sik LEE, Cheongju-si (KR)

(21) Appl. No.: 16/921,832

(22) Filed: Jul. 6, 2020

(30) Foreign Application Priority Data
Jul. 15, 2019 (KR) 10-2019-0085024

(51) Int. Cl. G09F 3/03; B32B 7/12; B32B 27/08; B32B 25/04

(52) U.S. Cl. CPC G09F 3/0305; B32B 7/12; B32B 27/08; G09F 2003/026; B32B 2405/00; B32B 2255/10; B32B 2519/00; B32B 25/04

(57) ABSTRACT

A security sticker in which a plurality of layers including a printed layer are stacked includes an anti-slip elastomer layer provided above or below the printed layer. The elastomer layer is formed on an entire surface of the printed layer and has a sheet shape having a predetermined thickness and a lateral surface length. Even when an external force pushes or pulls an upper surface of the security sticker in any direction, a bottom surface of the security sticker is provided to be deformed or elongated in a direction in which the external force is applied while the security sticker is attached to an original attachment position and to return to an original shape due to a restoring force when the external force is removed. The elastomer layer is formed of a material having an elongation of 150% or more compared to the lateral surface length or the thickness.

### CROSS-REFERENCE TO RELATED APPLICATION

This application claims priority to and the benefit of Korean Patent Application No. 10-2019-0085024, filed on Jul. 15, 2019, the disclosure of which is incorporated herein by reference in its entirety.

### BACKGROUND

### 1. Field of the Invention

The present invention relates to a security sticker, and more specifically, to a disposable security sticker used to seal a camera part of an electronic device, such as a mobile phone, or check whether a product package box, a confidential document box (an envelope) or the like is opened when a visitor enters and exits facilities that require security.

### 2. Discussion of Related Art

When a visitor visits a technology-driven company, such as a semi-conductor company, or a national agency that requires security, it is mandatory for a visitor carrying electronic devices, such as a mobile phone, a tablet personal computer (PC), a laptop computer, to attach a security sticker to a camera lens.

Recently, security stickers have been used to check whether a product package box or a confidential document box (an envelope) is opened.

The related arts for a security sticker are disclosed in Korean Laid-open Patent Application No. 10-2019-0074369 and Korean Registered Patent No. 10-1684376. In the former, a cutting line that passes through a sticker and release paper is formed so that damage or deformation is easily checked when a sticker is attached and then detached. In the latter, even when a sticker is detached and then reattached, traces remain on a portion from which the sticker is detached so that an unexpectedly broken seal is easily checked.

In the latter related art, as shown in FIG. 1, when a security sticker 12 is attached to a camera lens portion 2 of a mobile phone 1 and then is detached therefrom, an upper layer 14a of the sticker is separated from the security sticker 12, and a lower printed layer 14b is exposed on the camera lens portion 2, and thus whether a seal is released can be easily checked.

However, recently, in electronic devices, such as a mobile phone, as shown in FIGS. 1 and 2, the camera lens portion 2 is covered with tempered glass, and the security stickers 12 and 14 are eventually attached to the tempered glass. As a result, as shown in FIG. 2, when two index fingers 3 and 4 press the security stickers 12 and 14 and slowly push or pull the security stickers, the security stickers are easily detached from the camera lens portion 2 and need to be reattached to their original positions, and thus there is a problem in that the security stickers 12 and 14 do not function.

As described in the former related art, even when cutting lines are formed on stickers formed of a typical non-elastic material, as shown in FIG. 2, the stickers are detached from the camera lens portion 2 without damage or deformation due to the cutting lines and return to their original positions when the stickers are slowly pushed or pulled.

### SUMMARY OF THE INVENTION

The present invention is directed to providing a security sticker with an anti-slip elastomer layer.

According to an aspect of the present invention, there is provided a security sticker in which a plurality of layers including a printed layer are stacked and which includes an anti-slip elastomer layer provided on above or below the printed layer.

The elastomer layer may be formed above the printed layer with a first attachment unit disposed therebetween.

A coating layer may be further formed on the elastomer layer.

The elastomer layer may be formed below the printed layer with a second attachment unit disposed therebetween.

A third attachment unit may be further provided on the bottom of the elastomer layer, the second attachment unit may be a gluing agent, and the third attachment unit may be an adhesive.

The elastomer layer may be formed of a material that has an elongation of 150% or more compared to a thickness or a length thereof.

The elastomer layer may be a silicone gel sheet.

The elastomer layer may have a plurality of cutting lines formed to have a depth that is ½ or more of a thickness thereof.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a use state view illustrating a function and a problem of a conventional security sticker;

FIG. 2 is a use state view illustrating a function and a problem of a conventional security sticker;

FIG. 3 is a conceptual view illustrating the characteristics of a security sticker according to one embodiment of the present invention;

FIG. 4 is a conceptual view illustrating the characteristics of a security sticker according to one embodiment of the present invention;

FIG. 5 is a cross-sectional view of security stickers according to other embodiments of the present invention;

FIG. 6 is a cross-sectional view of security stickers according to other embodiments of the present invention;

FIG. 7 is a cross-sectional view of security stickers according to other embodiments of the present invention; and

FIG. 8 is a perspective view illustrating modified examples of an anti-slip elastomer layer of the present invention.

### DETAILED DESCRIPTION

Hereinafter, exemplary embodiments of the present invention will be described with reference to the accompanying drawings.

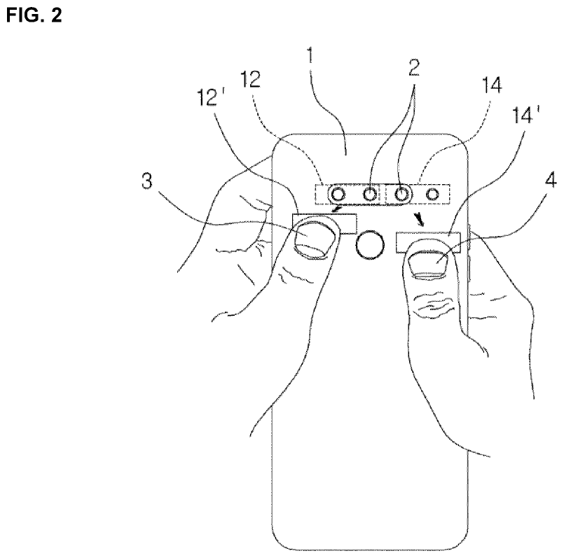

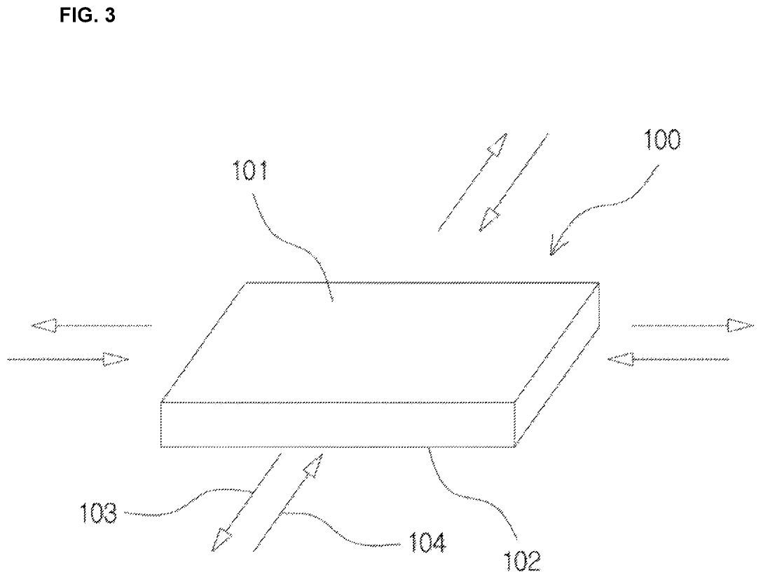

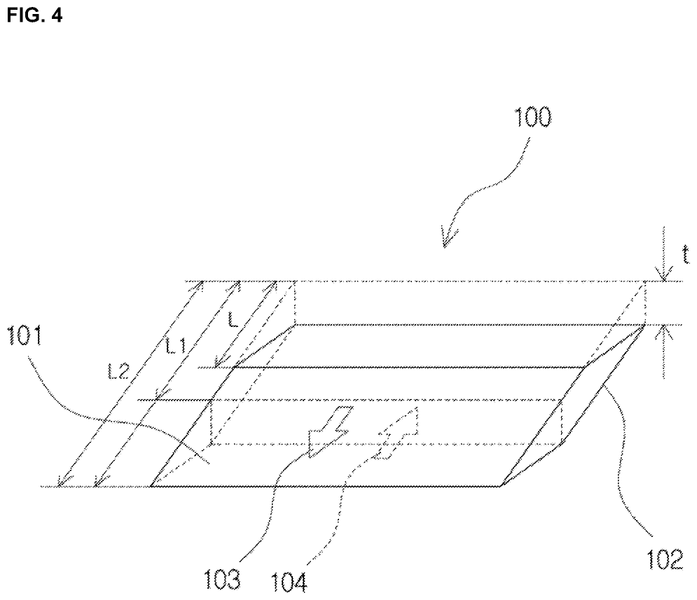

In the core technical concept of the present invention, a security sticker 100 in FIGS. 3 and 4 according to one embodiment includes an anti-slip elastomer layer, and a force is used to deform or elongate the elastomer layer even when fingers 3 and 4 touch and push or pull the security sticker as shown in FIG. 2, and thus the security sticker can be prevented from slipping from a sticker-attached position 2.

According to an embodiment to be described below, an upper surface 101 of the security sticker 100 may include a printed layer, which shows contents related to the security sticker, and an attachment unit which is formed on a bottom surface 102 of the security sticker 100 to be attached to an adherend.

As shown in FIGS. 3 and 4, the anti-slip elastomer layer refers to a material layer that is elongated or deformed in a direction in which an external force 103 is applied while the bottom surface 102 is attached to an original attachment position even when the upper surface 101 of the security sticker 100 is pushed or pulled in any direction, and returns to an original shape thereof due to a restoring force 104 when the external force is removed. The anti-slip elastomer layer may use any material layer that has the above-described characteristics. However, in an exemplary embodiment, the anti-slip elastomer layer may be formed of a typical elastomer, and more preferably, may be formed as a silicone rubber layer or a silicone gel sheet.

According to an embodiment, referring to FIG. 4, the anti-slip elastomer layer may be defined as a layer formed of a material that has an elongation of 150% or more compared to a thickness t or a length L1. In this case, the elongation is a value obtained by subtracting an original length from a length after elongation, dividing by the original length, and multiplying by 100. In the present invention, as an example in FIG. 4, the elongation may be calculated by (L/t)×100 or [(L2−L1)/L1])×100 to have a value of 150% or more.

Through the definition, when the elongation is less than 150%, similar to a conventional security sticker, there is a problem in that a force applied by the external force is directly transferred to the bottom surface 102 of the security sticker and the security sticker slips from tempered glass.

The thickness t of the anti-slip elastomer layer may vary according to embodiments, but may be less than or equal to at least 1/2.5 of a minimum width L1 in consideration of the minimum width L1 and the elongation of the security sticker 100. When the anti-slip elastomer layer is formed as a silicone rubber layer, the thickness thereof may be in the range of 0.4 to 0.5 mm.

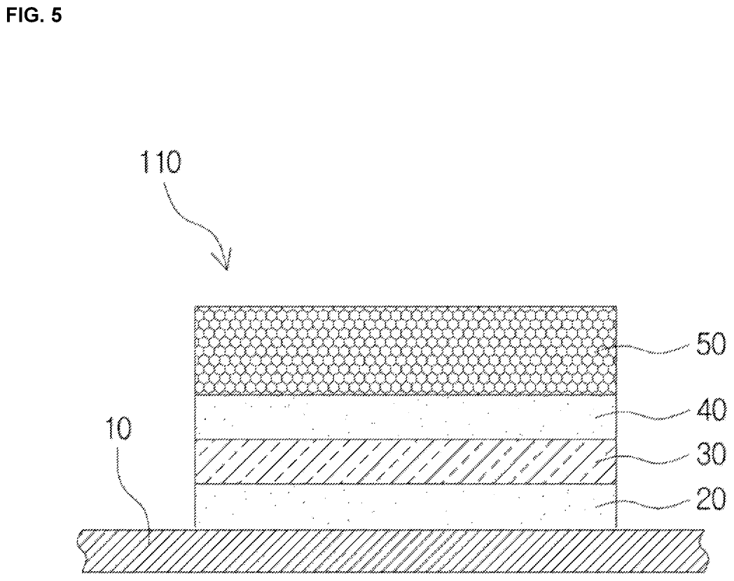

As exemplary embodiments of the present invention, as shown in FIGS. 5 to 7, each of security stickers 110, 120, and 130 is formed by stacking a plurality of layers including a printed layer 30 and may further include an anti-slip elastomer layer 50 formed above or below the printed layer 30.

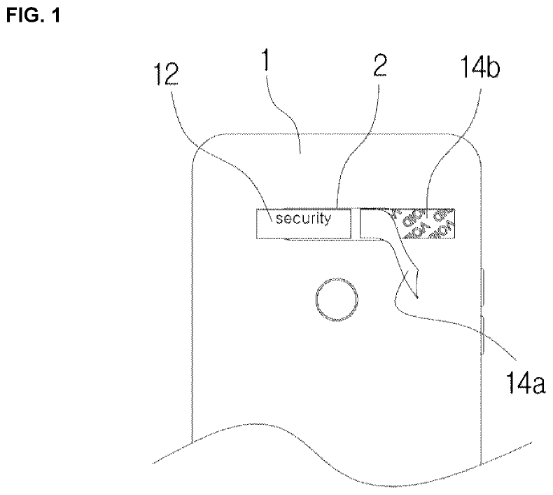

In FIG. 5, an embodiment is shown in which an anti-slip elastomer layer 50 is formed above the printed layer 30 with a first attachment unit 40 disposed therebetween. In this case, text or figures showing sticker contents may be printed only on an upper surface of the printed layer 30, but, when the sticker is detached, contents on a lower surface of the printed layer 30 may also be partially exposed (refer to FIG. 1) by a bottom attachment unit 20 in order to be attached to an adherend or release paper 10. In this case, an adhesive or a gluing agent that has more adhesion than the first attachment unit 40 may be applied to the bottom attachment unit 20.

According to an applied embodiment, in FIG. 5, the first attachment unit 40 is made of the same material as the anti-slip elastomer layer 50, but the first attachment unit 40 and the anti-slip elastomer layer 50 may be embodied as one elastomer layer (for example, a silicone gel layer) by increasing adhesion.

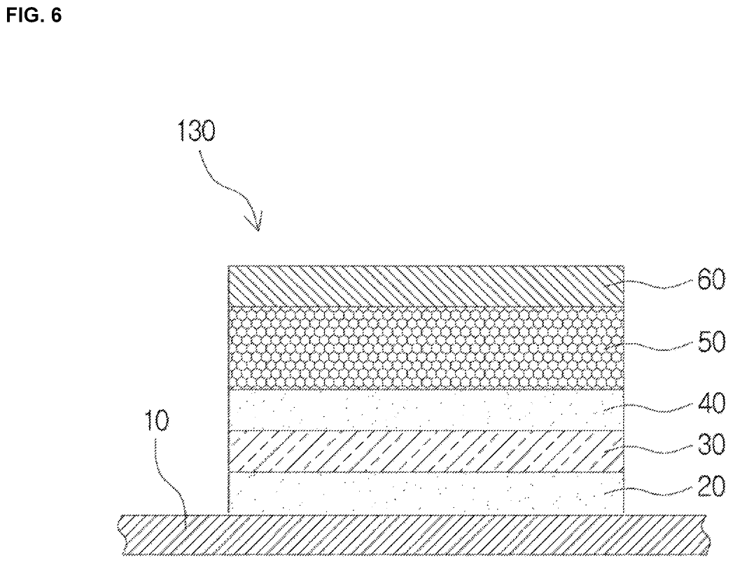

As shown in FIG. 6, one or more protective layers, such as a coating layer 60, may be further formed on an anti-slip elastomer layer 50. When the coating layer 60 serving as release paper 10 is formed at the top of a security sticker, the security sticker may be embodied as a roll-shaped tape.

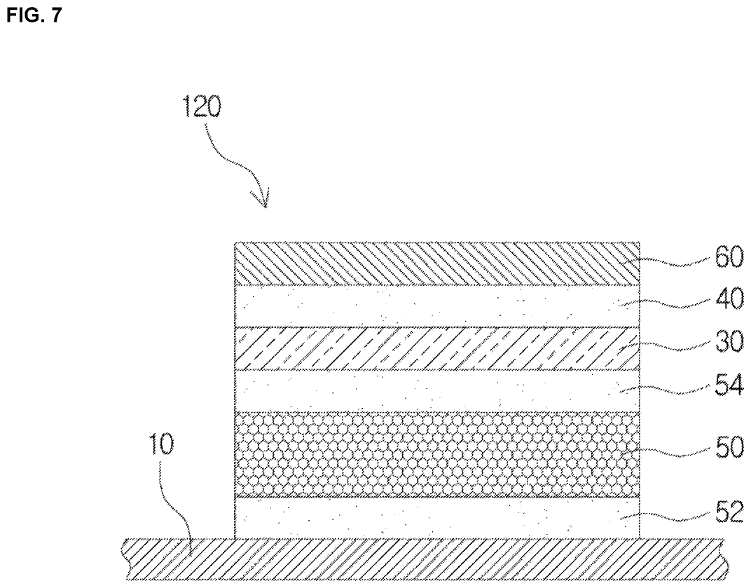

In FIG. 7, an embodiment is shown in which an anti-slip elastomer layer 50 is formed below the printed layer 30 with a second attachment unit 54 disposed therebetween. Here, the printed layer 30 may also be the same as that described in the embodiment in FIG. 5. However, an adhesive or a gluing agent may be applied to the second attachment unit 54 provided below the printed layer 30, wherein the adhesive or the gluing agent has more adhesion than the first attachment unit 40 provided above the printed layer 30.

According to an applied embodiment, as shown in FIG. 7, a third attachment unit 52 may be further provided on the bottom of the anti-slip elastomer layer 50, but two layers of the anti-slip elastomer layer 50 and the third attachment unit 52 may be embodied as one elastomer layer (for example, a silicone gel layer). Two layers of the elastomer layer 50/the second attachment unit 54 or three layers of the elastomer layer 50/the second attachment unit 54/the bottom attachment unit 52 may also be embodied of the same material as one elastomer layer (for example, a silicone gel layer). When the layers are embodied as one elastomer layer, upper and lower surfaces of the elastomer layer have increased adhesion so as to be attached to other layers.

As shown in FIG. 7, when the separate third attachment unit 52 is further provided below the anti-slip elastomer layer 50, an adhesive or a gluing agent may be formed as the third attachment unit 52 and have more adhesion than the second attachment unit 54 provided above the elastomer layer 50. As a specific embodiment, the second attachment unit 54 may be formed as a gluing agent, and the third attachment unit 52 may be formed as an adhesive.

In this case, the adhesive initially is present in a liquid state and is gradually hardened through processes of evaporation, cooling, reacting, and the like. When the adhesive is completely hardened, the adhesive is in a solid state, whereas a gluing agent is present in a semi-solid state over time. Due to this difference, the gluing agent has slight elasticity unlike the adhesive.

Therefore, in FIG. 7, the third attachment unit 52 to be attached to an adherend is prevented from slipping due to the adhesive, and the second attachment unit 54 on the elastomer layer 50 may compensate for deformation of the elastomer layer 50 due to the gluing agent.

Meanwhile, in FIG. 7, one or more protective layers, such as a coating layer 60, may be further formed on the printed layer 30. The coating layer 60 serving as release paper 10 is formed at the top of the security sticker, the security sticker may be embodied as a roll-shaped tape.

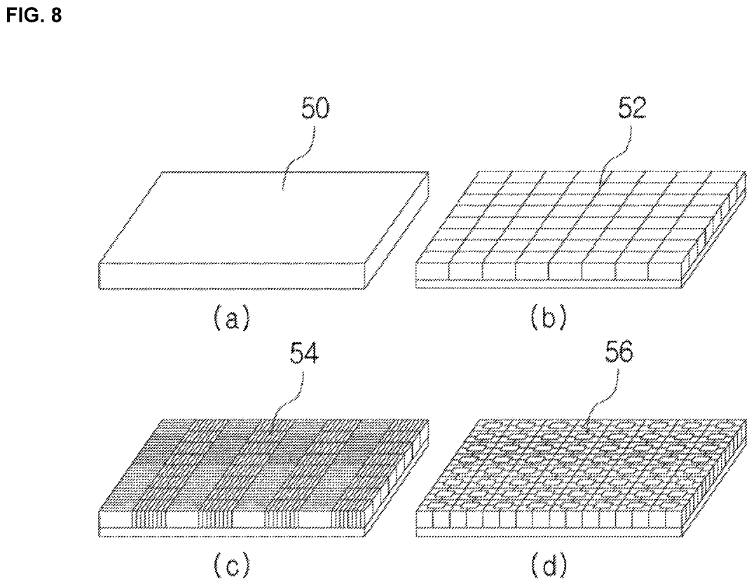

FIG. 8 is a perspective view illustrating modified examples of an anti-slip elastomer layer 50 of the present invention. As shown in FIG. 8A, the elastomer layer 50 of the present invention may be formed without any cutting line, but as shown in FIGS. 8B to 8D, a plurality of cutting lines 52, 54, 56 may be formed. As shown in FIG. 2, since the cutting lines 52, 54, 56 allow the elastomer layer 50 to be easily and partially torn due to an external force applied to the elastomer layer 50, which is cut into a plurality of pieces by the cutting lines, when the security sticker is pushed or pulled with thumbs 3 and 4 or the like, the cutting lines may have various shapes including the simple grid lines 52, the stripe lines 54 that perpendicularly cross each other, and the rectangle-included grid lines 56, and the like.

In some embodiments, the plurality of cutting lines 52, 54, 56 may be formed on a part of a surface of the elastomer layer 50, but as shown in FIG. 8, may be formed to have a depth that is ½ or more of the thickness t. The elastomer layer 50 may be formed of a porous material to increase a tear effect on a thickness portion in which the cutting lines 52, 54, 56 are not formed.

The security sticker according to the present invention further includes an anti-slip elastomer layer that is formed above or below a printed layer so that a force is used to deform or elongate the elastomer layer even when fingers touch and push or pull the security sticker so as to prevent the security sticker from slipping from an original attachment position.

Hereinabove, the present invention has been described with reference to the accompanying drawings, but a structure of the security sticker shown in the drawings may be variously changed. For example, an anti-slip elastomer layer may be further formed at the top of a conventional security sticker, interposed between layers, or be further formed at the bottom of the conventional security sticker.

What is claimed is:

1. A security sticker in which a plurality of layers including a printed layer are stacked, the security sticker comprising an anti-slip elastomer layer provided above or below the printed layer,
wherein the elastomer layer is formed on an entire surface of the printed layer and has a sheet shape having a predetermined thickness (t) and a lateral surface length (L1),
even when an external force pushes or pulls an upper surface of the security sticker in any direction, a bottom surface of the security sticker is provided to be deformed or elongated in a direction in which the external force is applied while the security sticker is attached to an original attachment position and to return to an original shape due to a restoring force when the external force is removed, and
the elastomer layer is formed of a material having an elongation of 150% or more compared to the lateral surface length (L1) or the thickness (t).

2. The security sticker of claim 1, wherein the elastomer layer is formed above the printed layer with a first attachment unit disposed therebetween.

3. The security sticker of claim 2, wherein a coating layer is further formed on the elastomer layer.

4. The security sticker of claim 1, wherein the elastomer layer is formed below the printed layer with a second attachment unit disposed therebetween.

5. The security sticker of claim 4, wherein a third attachment unit is further provided on the bottom of the elastomer layer,
the second attachment unit includes a gluing agent, and
the third attachment unit includes an adhesive.

6. The security sticker of claim 1, wherein the elastomer layer includes a silicone gel sheet.

7. The security sticker of claim 2, wherein the elastomer layer includes a silicone gel sheet.

8. The security sticker of claim 3, wherein the elastomer layer includes a silicone gel sheet.

9. The security sticker of claim 4, wherein the elastomer layer includes a silicone gel sheet.

10. The security sticker of claim 5, wherein the elastomer layer includes a silicone gel sheet.

11. The security sticker of claim 1, wherein the elastomer layer has a plurality of cutting lines formed to have a depth that is ½ or more of a thickness thereof.

12. The security sticker of claim 2, wherein the elastomer layer has a plurality of cutting lines formed to have a depth that is ½ or more of a thickness thereof.

13. The security sticker of claim 3, wherein the elastomer layer has a plurality of cutting lines formed to have a depth that is ½ or more of a thickness thereof.

14. The security sticker of claim 4, wherein the elastomer layer has a plurality of cutting lines formed to have a depth that is ½ or more of a thickness thereof.

15. The security sticker of claim 5, wherein the elastomer layer has a plurality of cutting lines formed to have a depth that is ½ or more of a thickness thereof.
